(19) United States
(12) Patent Application Publication
(10) Pub. No.: US 2026/0294195 A1
(43) Pub. Date: Oct. 1, 2026

(54) POOL SYSTEM WITH MESSAGE DIAGNOSTICS FOR POOL CLEANER

(71) Applicant: ZODIAC POOL CARE EUROPE, Belberaud (FR)

(72) Inventor: Simon Duffaut, Castelginest (FR)

(73) Assignee: ZODIAC POOL CARE EUROPE, Belberaud (FR)

(21) Appl. No.: 19/575,083

(22) Filed: Mar. 23, 2026

Related U.S. Application Data
(60) Provisional application No. 63/779,268, filed on Mar. 27, 2025.

(51) Int. Cl. A47L 9/28; A47L 9/30; E04H 4/16

(52) U.S. Cl. CPC A47L 9/2894; A47L 9/2857; A47L 9/30; E04H 4/1654; A47L 2201/06

(57) ABSTRACT

A pool system includes a self-propelled pool cleaner and a diagnostic system. The diagnostic system may receive visual data from a camera. The visual data may include a message light source on a pool cleaner and/or a control box for the pool cleaner, and the message light source may include a characteristic. The diagnostic system may analyze the at least one characteristic of the message light source in the visual data and determine a message associated with the at least one characteristic. Responsive to determining the message, the diagnostic system may cause a display remote from the pool cleaner to display the message.

### REFERENCE TO RELATED APPLICATION

This application claims the benefit of and priority to U.S. Provisional Patent Application No. 63/779,268, filed on Mar. 27, 2025, and entitled POOL SYSTEM WITH ERROR CODE DIAGNOSTICS FOR POOL CLEANER, the content of which is hereby incorporated by reference in its entirety.

### FIELD OF THE INVENTION

The invention relates to self-propelled pool cleaners for cleaning water-containing vessels such as swimming pools and spas.

### BACKGROUND

Self-propelled pool cleaners capable of autonomous or semi-autonomous movement within swimming pools and spas currently exist. The most common of these devices are automatic swimming pool cleaners, which often are either hydraulic or robotic in type. Hydraulic cleaners vary water flow for movement, while robotic cleaners typically employ electric motors to cause motion. Hydraulic pool cleaners, furthermore, subdivide into “pressure-side” and “suction-side” cleaners, with pressure-side cleaners being fluidly connected to outputs of pumps of pool water circulation systems and suction-side cleaners being fluidly connected to inputs of such pumps. Sometimes, a pool cleaner may experience an error. Conventionally, a user must rely on a user manual to troubleshoot and recognize the error. Such conventional approaches are susceptible to user error and/or assume that a user has access to the user manual provided with the pool cleaner.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various embodiments of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

According to certain embodiments, a method includes (i) receiving visual data from a camera with a message light source on a pool cleaner and having at least one characteristic, (ii) analyzing the at least one characteristic of the message light source in the visual data and determining a message associated with the at least one characteristic, and (iii) responsive to determining the message, causing a display remote from the pool cleaner to display the message.

According to some embodiments, a method includes (i) receiving visual data from a camera with a message light source on a control box for a corded pool cleaner and having at least one characteristic, (ii) analyzing the at least one characteristic of the message light source in the visual data and determining a message associated with the at least one characteristic, and (iii) responsive to determining the message, causing a display remote from the pool cleaner to display the message.

A non-transitory computer readable storage medium may include a plurality of instructions executable by one or more processors, which, when executed on the one or more processors, cause the one or more processors to perform actions including (i) receiving visual data from a camera with a message light source on a pool cleaner and having at least one characteristic, (ii) analyzing the at least one characteristic of the message light source in the visual data and determining a message associated with the at least one characteristic, and (iii) responsive to determining the message, causing a display remote from the pool cleaner to display the message.

A non-transitory computer readable storage medium may include a plurality of instructions executable by one or more processors, which, when executed on the one or more processors, cause the one or more processors to perform actions including (i) receiving visual data from a camera of a message light source on a control box for a corded pool cleaner and having at least one characteristic, (ii) analyzing the at least one characteristic of the message light source in the visual data and determining a message associated with the at least one characteristic, and (iii) responsive to determining the message, causing a display remote from the pool cleaner to display the message.

According to certain embodiments, a method includes (i) obtaining visual data of a message light source on a pool cleaner and/or a control box for a pool cleaner and comprising at least one characteristic using a camera, (ii) analyzing the at least one characteristic of the message light source in the visual data and determining a message associated with the at least one characteristic, and (iii) responsive to determining the message, causing a display remote from the pool cleaner to display the message.

According to some embodiments, a method includes (i) receiving visual data from a camera having a field of view, (ii) determining whether a message light source on a pool cleaner and/or on a control box for a pool cleaner is within the field of view based on the visual data, (iii) responsive to determining that the message light source is within the field of view, determining at least one characteristic of the message light source based on the visual data and determining a message associated with the at least one characteristic, and (iv) responsive to determining the message, causing a display remote from the pool cleaner to display the message.

A non-transitory computer readable storage medium may include a plurality of instructions executable by one or more processors, which, when executed on the one or more processors, cause the one or more processors to perform actions including (i) receiving visual data from a camera having a field of view, (ii) determining whether a message light source on a pool cleaner and/or on a control box for a pool cleaner is within the field of view based on the visual data, (iii) responsive to determining that the message light source is within the field of view, determining at least one characteristic of the message light source based on the visual data and determining a message associated with the at least one characteristic, and (iv) responsive to determining the message, causing a display remote from the pool cleaner to display the message.

According to certain embodiments, a method of controlling a self-propelled pool cleaner includes causing the pool cleaner and/or a control box for the pool cleaner to display a message on the pool cleaner with light outside of the visible light spectrum responsive to a message event, such as but not limited to an error event.

According to some embodiments, a self-propelled pool cleaner is configured to display a message on the pool cleaner and/or on a control box for the pool cleaner with light outside of the visible light spectrum.

A non-transitory computer readable storage medium may include a plurality of instructions executable by one or more processors, which, when executed on the one or more processors, cause the one or more processors to perform actions including causing a pool cleaner to display a message on the pool cleaner and/or on a control box for the pool cleaner. with light outside of the visible light spectrum responsive to a message event, such as but not limited to an error event.

According to certain embodiments, a pool system includes a self-propelled pool cleaner, and the pool system is configured to display a message with light outside of the visible light spectrum responsive to a message event, such as but not limited to an error event.

According to some embodiments, a pool system includes a self-propelled pool cleaner and a diagnostic system. The diagnostic system is configured to obtain visual data of a message light source on the self-propelled pool cleaner and/or a control box for the self-propelled pool cleaner, the message light source comprising at least one characteristic using a camera, analyze the at least one characteristic of the message light source in the visual data and determine a message associated with the at least one characteristic, and responsive to determining the message, cause a display remote from the self-propelled pool cleaner to display the message.

Various implementations described in the present disclosure can include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The features and components of the following figures are illustrated to emphasize the general principles of the present disclosure. Corresponding features and components throughout the figures can be designated by matching reference characters for the sake of consistency and clarity.

FIG. 1 illustrates a pool system with a diagnostic system according to embodiments.

FIG. 2 illustrates the pool system with the diagnostic system of FIG. 1 according to embodiments.

### DETAILED DESCRIPTION

Described herein are pool systems with self-propelled pool cleaners for swimming pools and spas and systems and methods for obtaining and/or diagnosing messages from pool cleaners. In one non-limiting example, the messages may be error codes on such pool cleaners, although in other embodiments they may be other messages with other information as desired.

In some embodiments, the systems and methods described herein include one or more pool cleaners configured to display a message using a message light source. The message light source may be on the pool cleaner itself (for corded or cordless pool cleaners) and/or may be on a control box if the pool cleaner is a corded pool cleaner.

In various embodiments, the pool cleaner may control the message light source responsive to a message event. Message events may include events that may be experienced by a pool cleaner, such as but not limited to a status event (e.g., completion of a cleaning cycle, a scheduled message, a navigation to a location, a completion of charging, combinations thereof, etc.), an error event, combinations thereof, and/or as otherwise desired, and thus should not be considered limiting. In a non-limiting example, a message event may be an error event. Non-limiting of error events include but are not limited to communication errors (e.g., the pool cleaner cannot communicate with a power supply), a motor issue, a power issue, a drive system error, an out of water error, a pump error, a general error, combinations thereof, and/or as otherwise desired. In other embodiments, the pool cleaner may control the message light source responsive to other events and/or to convey other information as desired, and the message need to be an error code message.

Optionally, the message light source emits light outside of the visible light spectrum, although it need not in other embodiments.

The systems and methods described herein may utilize visual data from a camera to interpret the message light source, determine a message based on the visual data, display the message to a user, and optionally provide troubleshooting and/or additional information associated with the message to the user. In a non-limiting example, the systems and methods may interpret the message light source, determine an error code based on the visual data, display the error code to a user, and optionally provide troubleshooting associated with the error code to the user.

In some embodiments, the systems and methods described herein may automatically determine the message (e.g., responsive to the receipt of visual data, responsive to determining the message is within a field of view and/or has a message status, combinations thereof, etc.). Additionally, or alternatively, the systems and methods described herein may determine the message responsive to a user input (e.g., a user may provide input on a user device, such as but not limited to a smartphone, to initiate a message determination). Optionally, in addition to message information, the message light source may provide supplemental and/or auxiliary information which may be determined and/or provided to a user using the systems and methods described herein.

Compared to traditional approaches, the systems and methods described herein reduce and/or eliminate user error recognizing a message (such as but not limited to an error code and/or other information conveyed by the pool cleaner). Additionally, or alternatively, the systems and methods provided herein facilitate troubleshooting by determining a message and providing the message to the user, optionally with troubleshooting information, thereby reducing and/or eliminating reliance on a user's ability to locate or interpret a user manual. Various other benefits and advantages may be realized with the systems, devices, and methods provided herein, and the aforementioned advantages should not be considered limiting.

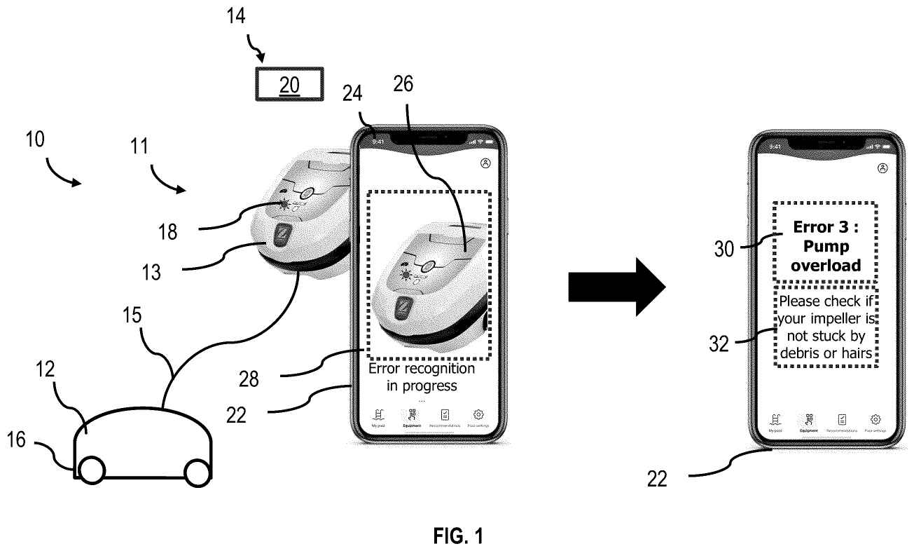

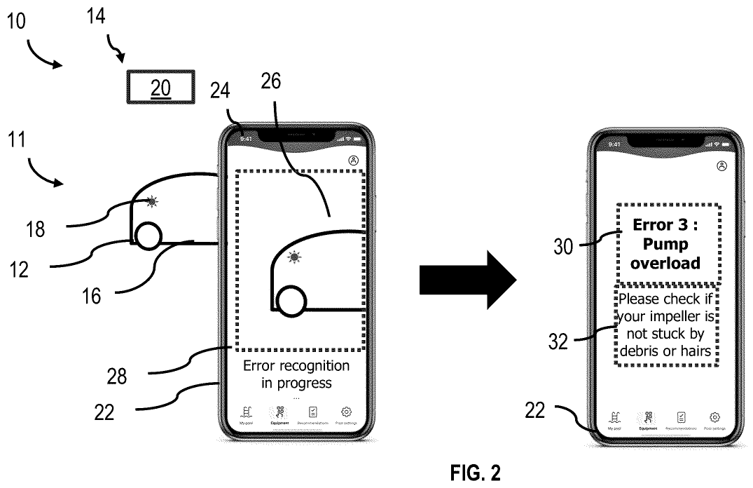

FIGS. 1 and 2 illustrate a pool system 10 with a pool cleaner system 11 with at least a pool cleaner 12 and a diagnostic system 14 according to embodiments.

The pool cleaner 12 of the pool cleaner system 11 may be self-propelled and may be various types of cleaners capable of autonomous or semi-autonomous movement within a pool or spa. In certain embodiments, the pool cleaner 12 may be a robotic cleaner using electrical power for movement and cleaning. In some embodiments, and as illustrated in FIG. 1, the pool cleaner 12 is a corded pool cleaner 12, and the pool cleaner system 11 additionally includes a control box 13 coupled to the pool cleaner 13 via cabling 15. However, in other embodiments, and as illustrated in FIG. 2, the pool cleaner 12 may be cordless and the pool cleaner system 11 need not include the control box 13. Additionally, or alternatively, the pool cleaner 12 may be a hydraulic cleaner utilizing water flow and/or water jets for movement.

The pool cleaner 12 may generally include a body or housing 16 with one or more inlets and one or more outlets. One or more motive elements (e.g., wheels, tracks, rollers, propellers, feet, combinations thereof, etc.) may allow or enable movement of the pool cleaner 12 within the pool or spa. In some embodiments, the pool cleaner 12 may include one or more cleaning devices (including but not limited to one or more brush assemblies). A motor, a pump, a filter, a control system (processor and/or memory), and/or various other features or combinations of features may be provided on or within the pool cleaner 12 as desired. As a non-limiting example, the pool cleaner 12 may include a filter, and debris-laden water may enter the pool cleaner 12 (e.g., from one or more inlets), with the filter stopping or capturing at least some of the debris before allowing filtered water to exit (e.g., through one or more outlets). In certain embodiments, the pool cleaner 12 includes an on-board power source, such as but not limited to one or more on-board batteries. Non-limiting examples of pool cleaners 12 may include those described in U.S. Pat. Nos. 10,316,534, 9,488,154, 8,578,538, and/or U.S. Patent Publication No. 2014/0303810, all of which are hereby incorporated by reference in their entireties.

In various embodiments, and as illustrated in FIGS. 1 and 2, the pool cleaner system 11 includes one or more message light sources 18. The one or more message light sources may be provided on the control box 13 (if included) as illustrated in FIG. 1, the pool cleaner 12 (see, e.g., FIG. 2), or both the pool cleaner 12 and the control box 13. Moreover, in embodiments where the pool cleaner 12 is corded, the one or more message light sources 18 may be provided on the pool cleaner 12 and need not be provided on the control box 13. As such, the number and location of the message light sources 18 included on (or coupled with) the pool cleaner 12, the control box 11, and/or other components of the pool cleaner system 11 should not be considered limiting.

The one or more message light sources 18 are various devices suitable for emitting light. In some embodiments, the message light sources 18 may emit light in the visible light spectrum. Additionally, or alternatively, the message light sources 18 may emit outside the visible light spectrum (e.g., they are invisible to a human). As a non-limiting example, one or more message light sources 18 may emit infrared light; however, other wavelengths may be utilized as desired.

In a non-limiting example, the one or more message light sources 18 may be controlled (e.g., by the pool cleaner 12 and/or the control box 13) to emit light at least responsive to a message event. In a non-limiting example, the one or more message light sources 18 may be controlled responsive to an error code event as the message event. Error code events may include various error events that may be experienced by a pool cleaner. Non-limiting of error code events include but are not limited to communication errors, a power supply error, a motor issue, a power issue, a drive system error, an out of water error, a pump error, a general error, combinations thereof, and/or as otherwise desired. The particular error code event resulting in the activation and/or control of the error code light sources 18 should not be considered limiting. In other embodiments, the message light sources 18 may be controlled responsive to other events and/or as otherwise desired by the pool cleaner 12 to convey and/or provide information as a message.

In various embodiments, at least one characteristic of the light emitted by the one or more message light sources 18 may be controlled to indicate a particular message. Non-limiting examples of characteristics of the light from the one or more message light sources 18 that may be controlled include, but are not limited to, a color of the light, an intensity of the light, a status of the light (e.g., on/off), a blinking pattern of the light, a duration of the blinking pattern and/or activation of the light, combinations thereof, and/or as otherwise desired.

In a non-limiting example, the characteristic of the light may be controlled to indicate a particular error code. As a non-limiting example, based on the pool cleaner having an error event of a pump overload, the message light source 18 may be activated to emit light in the color red and in blinking pattern at a one second interval. As a further non-limiting example, based on the pool cleaner 12 having an error event of a power supply error, the message light source 18 may be activated to emit light in the color blue and in a blinking pattern at a two second interval. As yet another non-limiting example, based on the pool cleaner 12 having an error event of a communication error, the message light source 18 may be activated to emit light in the color red and continuously on/without a blinking pattern. Other characteristics may be utilized as desired to display different error codes.

As illustrated in FIGS. 1 and 2, the diagnostic system 14 includes a control system 20 (processing unit and/or memory device) and one or more cameras 24.

The processing unit of the control system 20 may be any suitable processing device or combinations of devices including but not limited to one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units, and/or a combination thereof. The one or more memory devices of the control system 20 may be any machine-readable medium that can be accessed by the processor, including but not limited to any type of long term, short term, volatile, nonvolatile, or other storage medium, and is not to be limited to any particular type of memory or number of memories, or type of media upon which memory is stored. Moreover, as disclosed herein, the term “storage medium,” “storage” or “memory” can represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to, portable or fixed storage devices, optical storage devices, wireless channels, and/or various other storage mediums capable of storing that contain or carry instruction(s) and/or data.

In certain embodiments, the control system 20 optionally includes an associated user interface, including but not limited to a human machine user interface, such that the control system 20 may obtain information from a user and/or provide information to the user via the user interface. When included, the user interface may be on the control system 20 itself or may be at a location remote from the control system 20 such as, but not limited to, another location within the pool system 10. Additionally, or alternatively, the control system 20 optionally may include one or more communication modules such that the control system 20 may receive and/or send information to a user device and/or other location. Non-limiting examples of communication modules may include systems and mechanisms enabling wired communication and/or wireless communication (e.g., near field, cellular, Wi-Fi, Bluetooth®, Bluetooth Low Energy (BLE), low-power wide area network, cloud-based communication etc.). In one non-limiting example, the control system 20 may receive from and/or send information to a user device 22 via an application running on the user device 22. In some embodiments, the control system 20 and/or portions thereof may be a dedicated system, although in other embodiments, the control system 20 may be included with another component, such as but not limited to the user device 22.

The cameras 24 may be various imaging devices configured to obtain visual data, such as but not limited to one or more images, of at least a portion of the pool cleaner 12 (see, e.g., FIG. 2), a portion of the control box 13 (see, e.g., FIG. 1), and/or other portions of the pool cleaner system 11 with the message light source(s) 18. In some embodiments, the cameras 24 may be provided as a component of another device, such as but not limited to the diagnostic system 14 (which may be part of the user device 22) or the user device 22. As non-limiting examples, one or more cameras 24 may include optical or video cameras, single or multi-stereo cameras, laser-based cameras, thermal (e.g., infrared) cameras, visible light cameras, red-green-blue depth (RGB-D) cameras, combinations thereof, and/or other devices as desired. In certain embodiments, the one or more cameras 24 may be configured to detect light in the visible light spectrum and/or outside the visible light spectrum.

In various embodiments, the control system 20 is communicatively coupled to the one or more cameras 24 such that the control system 20 receives visual data from the one or more cameras and performs various operations based on the visual data.

The control system 20 may receive visual data having a field of view 26 of a portion of the pool cleaner system 11 and may analyze the visual data to identify the message light source and at least one characteristic of the light emitted by the message light source 18. In FIG. 1 the control system may receive visual data having the field of view 26 including a portion of the control box 13. In FIG. 2 the control system 20 may receive visual data having a field of view 26 including a portion of the pool cleaner 12. In some embodiments, the control system 20 may receive visual data from the camera and determine whether a message light source 18 on a pool cleaner 12, control box 13, and/or other component of the pool cleaner system 11 is within the field of view 26.

In certain embodiments, the control system 20 may determine or recognize a message associated with at least one characteristic of the light detected in the visual data. As mentioned, in some embodiments, the light emitted by the message light source 18 may be in the visible light spectrum, although it need not be, and the light additionally or alternatively may be outside of the visible light spectrum. In one non-limiting example, the light from the message light source 18 may be infrared light.

In some embodiments, the control system 20 may automatically determine or recognize the message, while in other embodiments, the control system 20 may perform the analysis or determination responsive to input from a user on the user device 22. As non-limiting examples, the control system 20 may determine the message based on a color of the light, an intensity of the light, a status of the light (e.g., on/off), a blinking pattern of the light, a duration of the blinking pattern and/or activation of the light, combinations thereof, and/or as otherwise desired.

In various embodiments, the control system 20 may cause a display 28 to display the determined message 30. In such embodiments, the display 28 may be various displays and/or at various locations as desired. In some embodiments, the display 28 is the display of the user device 22 and/or the camera 24 and display 28 may be on a common device, although they need not be in other embodiments. In certain embodiments, the display 28 is a display which is remote from/not attached to the pool cleaner 12.

Optionally, and as illustrated in FIG. 1, the control system 20 may cause the display 28 to display the visual data and/or field of view 26 obtained from the camera 24.

Optionally, the control system 20 may determine and/or obtain troubleshooting information associated with the determined message. In some embodiments, and as illustrated in FIG. 1, the control system 20 may cause the display 28 to further display the determined or obtained troubleshooting information 32.

Optionally, the light emitted by the message light source 18 may provide supplemental information in addition to the message. The supplemental information may or may not be related to the message as desired. In embodiments where the message light source 18 communicates the supplemental information in addition to the message, the control system 20 may determine and/or obtain the supplemental information based on the at least one characteristic of the light emitted by the message light source 18, and the control system 20 optionally may cause the display 28 to further display the supplemental information.

Various other combinations of features may be utilized as desired, and the aforementioned examples should not be considered limiting.

Exemplary concepts or combinations of features of the invention may include:
A. A method comprising:
   i. receiving visual data from a camera, the visual data comprising a message light source on a pool cleaner and comprising at least one characteristic;
   ii. analyzing the at least one characteristic of the message light source in the visual data and determining a message associated with the at least one characteristic; and
   iii. responsive to determining the message, causing a display remote from the pool cleaner to display the message.
B. A method comprising:
   i. receiving visual data from a camera, the visual data comprising a message light source on a control box for a corded pool cleaner and comprising at least one characteristic;
   ii. analyzing the at least one characteristic of the message light source in the visual data and determining a message associated with the at least one characteristic; and
   iii. responsive to determining the message, causing a display remote from the pool cleaner to display the message.
C. The method, instructions, system, or cleaner of any preceding or subsequent statement of combination of statements, further comprising:
   i. responsive to determining the message, determining and/or obtaining troubleshooting information associated with the determined message; and
   ii. causing the display remote from the pool cleaner to display the troubleshooting information.
D. The method, instructions, system, or cleaner of any preceding or subsequent statement of combination of statements, further comprising:
   i. responsive to receiving the visual data, analyzing the at least one characteristic of the message light source in the visual data and determining supplemental information associated with the at least one characteristic.
E. The method, instructions, system, or cleaner of any preceding or subsequent statement of combination of statements, further comprising causing the display to display the supplemental information.
F. The method, instructions, system, or cleaner of any preceding or subsequent statement of combination of statements, wherein the camera and the display are on a common device.
G. The method, instructions, system, or cleaner of any preceding or subsequent statement of combination of statements, wherein the at least one characteristic of the message light source comprises at least one of a color of light from the message light source, a blinking pattern of light from the message light source, a duration of the blinking pattern, combinations thereof, and/or as otherwise desired.
H. The method, instructions, system, or cleaner of any preceding or subsequent statement of combination of statements, wherein the visual data comprises light from the message light source outside of the visible light spectrum.
I. The method, instructions, system, or cleaner of any preceding or subsequent statement of combination of statements, wherein the message is an error code.
J. The method, instructions, system, or cleaner of any preceding or subsequent statement of combination of statements, wherein analyzing the at least one characteristic is responsive to receiving the visual data.
K. The method, instructions, system, or cleaner of any preceding or subsequent statement of combination of statements, wherein analyzing the at least one characteristic is responsive to receiving a user input.
L. A non-transitory computer readable storage medium comprising a plurality of instructions executable by one or more processors, which, when executed on the one or more processors, cause the one or more processors to perform actions including:
   i. receiving visual data from a camera, the visual data comprising a message light source on a pool cleaner and comprising at least one characteristic;
   ii. analyzing the at least one characteristic of the message light source in the visual data and determining a message associated with the at least one characteristic; and
   iii. responsive to determining the message, causing a display remote from the pool cleaner to display the message.
M. A non-transitory computer readable storage medium comprising a plurality of instructions executable by one or more processors, which, when executed on the one or more processors, cause the one or more processors to perform actions including:
   i. receiving visual data from a camera, the visual data comprising a message light source on a control box for a corded pool cleaner and comprising at least one characteristic;
   ii. analyzing the at least one characteristic of the message light source in the visual data and determining a message associated with the at least one characteristic; and
   iii. responsive to determining the message, causing a display remote from the pool cleaner to display the message.
N. A method comprising:
   i. obtaining visual data of a message light source on a pool cleaner and/or a control box for a pool cleaner and comprising at least one characteristic using a camera;
   ii. analyzing the at least one characteristic of the message light source in the visual data and determining a message associated with the at least one characteristic; and
   iii. responsive to determining the message, causing a display remote from the pool cleaner to display the message.
O. A method comprising:
   i. receiving visual data from a camera having a field of view;
   ii. determining whether a message light source on a pool cleaner and/or on a control box for a pool cleaner is within the field of view based on the visual data;
   iii. responsive to determining that the message light source is within the field of view, determining at least one characteristic of the message light source based on the visual data and determining a message associated with the at least one characteristic; and
   iv. responsive to determining the message, causing a display remote from the pool cleaner to display the message.
P. A non-transitory computer readable storage medium comprising a plurality of instructions executable by one or more processors, which, when executed on the one or more processors, cause the one or more processors to perform actions including:
   i. receiving visual data from a camera having a field of view;
   ii. determining whether a message light source on a pool cleaner and/or on a control box for a pool cleaner is within the field of view based on the visual data;
   iii. responsive to determining that the message light source is within the field of view, determining at least one characteristic of the message light source based on the visual data and determining a message associated with the at least one characteristic; and
   iv. responsive to determining the message, causing a display remote from the pool cleaner to display the message.
Q. A method of controlling a self-propelled pool cleaner, the method comprising causing the pool cleaner and/or a control box for the pool cleaner to display a message on the pool cleaner with light outside of the visible light spectrum responsive to an error event.
R. A self-propelled pool cleaner configured to display a message on the pool cleaner and/or on a control box for the pool cleaner with light outside of the visible light spectrum.
S. A non-transitory computer readable storage medium comprising a plurality of instructions executable by one or more processors, which, when executed on the one or more processors, cause the one or more processors to perform actions including causing a pool cleaner to display a message on the pool cleaner and/or on a control box for the pool cleaner, with light outside of the visible light spectrum responsive to an error event.
T. The method, instructions, system, or cleaner of any preceding or subsequent statement of combination of statements, wherein obtaining the visual data comprises: receiving visual data from a camera having a field of view, and determining whether the message light source on the pool cleaner and/or on the control box for a pool cleaner is within the field of view based on the visual data, wherein analyzing the at least one characteristic is responsive to responsive to determining that the message light source is within the field of view.
U. A non-transitory computer readable storage medium comprising a plurality of instructions executable by one or more processors, which, when executed on the one or more processors, cause the one or more processors to perform actions including the method of any preceding or subsequent statement or combination of statements.
V. The method, instructions, system, or cleaner of any preceding or subsequent statement of combination of statements, wherein causing the pool system to display the message comprises causing the self-propelled pool cleaner to display the message.
W. The method, instructions, system, or cleaner of any preceding or subsequent statement of combination of statements, wherein causing the pool system to display the message comprises causing a control box connected to the self-propelled pool cleaner to display the message.
X. A pool system comprising a self-propelled pool cleaner, wherein the pool system is configured to display a message with light outside of the visible light spectrum responsive to an error event.
Y. The method, instructions, system, or cleaner of any preceding or subsequent statement of combination of statements, wherein the pool system is configured to display the message on the self-propelled pool cleaner.
Z. The method, instructions, system, or cleaner of any preceding or subsequent statement of combination of statements, wherein the pool system is configured to display the message on a control box connected to the self-propelled pool cleaner.
AA. The method, instructions, system, or cleaner of any preceding or subsequent statement of combination of statements, further comprising a diagnostic system configured to detect the message.
BB. The method, instructions, system, or cleaner of any preceding or subsequent statement of combination of statements, wherein the pool system is configured to display the message by controlling at least one characteristic of one or more message light sources.
CC. A pool system comprising a self-propelled pool cleaner and a diagnostic system, wherein the diagnostic system is configured to obtain visual data of a message light source on the self-propelled pool cleaner and/or a control box for the self-propelled pool cleaner, the message light source comprising at least one characteristic using a camera, analyze the at least one characteristic of the message light source in the visual data and determine a message associated with the at least one characteristic, and responsive to determining the message, cause a display remote from the self-propelled pool cleaner to display the message
DD. The method, instructions, system, or cleaner of any preceding or subsequent statement of combination of statements, wherein the pool system is configured to display the message using light outside of the visible light spectrum responsive to an error event.

These examples are not intended to be mutually exclusive, exhaustive, or restrictive in any way, and the invention is not limited to these example embodiments but rather encompasses all possible modifications and variations within the scope of any claims ultimately drafted and issued in connection with the invention (and their equivalents). For avoidance of doubt, any combination of features not physically impossible or expressly identified as non-combinable herein may be within the scope of the invention. Further, although applicant has described devices and techniques for use principally with pool cleaners, persons skilled in the relevant field will recognize that the present invention conceivably could be employed in connection with other objects and in other manners. Finally, references to “pools” and “swimming pools” herein may also refer to spas or other water containing vessels used for recreation, training, or therapy and for which cleaning of debris is needed or desired.

As used herein, the meaning of “a,” “an,” and “the” includes singular and plural references unless the context clearly dictates otherwise.

The subject matter of embodiments of the present disclosure is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described. A zero angle refers to an angle of 0°or 180°. Directional references such as “up,” “down,” “top,” “bottom,” “left,” “right,” “vertical,” “horizontal,” “lateral,” “longitudinal,” “front,” and “back,” among others, are intended to refer to the orientation as illustrated and described in the figure (or figures) to which the components and directions are referencing.

The terms “comprising,” “having,” “including,” and “containing” are to be construed as open-ended terms (i.e., meaning “including, but not limited to,”) unless otherwise noted. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

The above-described aspects are merely possible examples of implementations, merely set forth for a clear understanding of the principles of the present disclosure. Many variations and modifications can be made to the above-described embodiment(s) without departing substantially from the spirit and principles of the present disclosure. All such modifications and variations are intended to be included herein within the scope of the present disclosure, and all possible claims to individual aspects or combinations of elements or steps are intended to be supported by the present disclosure. Moreover, although specific terms are employed herein, as well as in the claims that follow, they are used only in a generic and descriptive sense, and not for the purposes of limiting the described embodiments, nor the claims that follow.

1. A method comprising:
obtaining visual data of a message light source on a pool cleaner and/or a control box for a pool cleaner and comprising at least one characteristic using a camera;
analyzing the at least one characteristic of the message light source in the visual data and determining a message associated with the at least one characteristic; and
responsive to determining the message, causing a display remote from the pool cleaner to display the message.

2. The method of claim 1, wherein the message light source is on the pool cleaner.

3. The method of claim 1, wherein the message light source is on the control box.

4. The method of claim 1, further comprising:
responsive to determining the message, determining and/or obtaining troubleshooting information associated with the determined message; and
causing the display remote from the pool cleaner to display the troubleshooting information.

5. The method of claim 1, further comprising, responsive to receiving the visual data, analyzing the at least one characteristic of the message light source in the visual data and determining supplemental information associated with the at least one characteristic.

6. The method of claim 5, further comprising causing the display to display the supplemental information.

7. The method of claim 1, wherein the camera and the display are on a common device.

8. The method of claim 1, wherein the at least one characteristic of the message light source comprises at least one of a color of light from the message light source, a blinking pattern of light from the message light source, a duration of the blinking pattern, or combinations thereof.

9. The method of claim 1, wherein the visual data comprises light from the message light source outside of the visible light spectrum.

10. The method of claim 1, wherein analyzing the at least one characteristic is responsive to receiving the visual data or receiving a user input.

11. The method of claim 1, wherein obtaining the visual data comprises:
receiving visual data from a camera having a field of view; and
determining whether the message light source on the pool cleaner and/or on the control box for a pool cleaner is within the field of view based on the visual data,
wherein analyzing the at least one characteristic is responsive to responsive to determining that the message light source is within the field of view.

12. A non-transitory computer readable storage medium comprising a plurality of instructions executable by one or more processors, which, when executed on the one or more processors, cause the one or more processors to perform actions including the method of claim 1.

13. A pool system comprising a self-propelled pool cleaner, wherein the pool system is configured to display a message with light outside of the visible light spectrum responsive to an error event.

14. The pool system of claim 13, wherein the pool system is configured to display a message with light outside of the visible light spectrum responsive to an error event.

15. The pool system of claim 13, wherein the pool system is configured to display the message on the self-propelled pool cleaner.

16. A pool system comprising:
a self-propelled pool cleaner; and
a diagnostic system, wherein the diagnostic system is configured to:
obtain visual data of a message light source on the self-propelled pool cleaner and/or a control box for the self-propelled pool cleaner, the message light source comprising at least one characteristic using a camera;
analyze the at least one characteristic of the message light source in the visual data and determine a message associated with the at least one characteristic; and
responsive to determining the message, cause a display remote from the self-propelled pool cleaner to display the message.

17. The pool system of claim 16, wherein the pool system is configured to display the message on the self-propelled pool cleaner.

18. The pool system of claim 16, wherein the pool system is configured to display the message on a control box connected to the self-propelled pool cleaner.

19. The pool system of claim 16, wherein the pool system is configured to display the message with the message light source using light outside of the visible light spectrum responsive to an error event.

20. The pool system of claim 19, wherein the pool system is configured to display the message by controlling at least one characteristic of one or more message light sources.
